(19) United States
(12) Patent Application Publication
(10) Pub. No.: US 2023/0416536 A1
(43) Pub. Date: Dec. 28, 2023

(54) POWDER COATING PRIMER

(71) Applicant: Pulver Kimya San. Ve Tic A.S., Gebze (TR)

(72) Inventors: Martin Michael WITTIG, Darmstadt (DE); Ekkehard Scobel, Dresden (DE); Hüseyin Çagatay Pakkan, Gebze (TR); Seniz Ünalan Okar, Gebze (TR)

(73) Assignee: Pulver Kimya San. Ve Tic A.S., Gebze (TR)

(21) Appl. No.: 18/465,546

(22) Filed: Sep. 12, 2023

Related U.S. Application Data
(63) Continuation of application No. PCT/EP2022/056274, filed on Mar. 10, 2022.

(30) Foreign Application Priority Data
Mar. 12, 2021 (EP) 21162460.6

(51) Int. Cl. C09D 5/00; C09D 5/03; C09D 7/61

(52) U.S. Cl. CPC C09D 5/002; C09D 5/033; C09D 7/61

(57) ABSTRACT

A primer composition for coating a substrate prior to application thereon of an intumescent fire protecting coating composition, the primer composition being a powder coating composition consisting of an extruded and subsequently ground mixture of binding agents, hardening agents and optionally one or more of optional pigments, optional filler, and optional additives, and a porous material in a proportion of one to twelve percent by weight of the powder coating composition. The porous material is mesoporous or microporous.

### CROSS-REFERENCE TO RELATED APPLICATIONS

This application is a continuation of International Application No. PCT/EP2022/056274, filed on Mar. 10, 2022, which claims priority to and the benefit of EP 21162460.6 filed on Mar. 12, 2021. The disclosures of the above applications are incorporated herein by reference.

### FIELD

The present disclosure relates to a primer composition and system for coating a substrate prior to application thereon of an intumescent fire protecting coating.

### BACKGROUND

The statements in this section merely provide background information related to the present disclosure and may not constitute prior art.

GB 2 385 856 A discloses a water-based primer composition for coating a substrate prior to application thereon of a fire protecting coating composition, the primer composition including a water-soluble alkali metal silicate and a polymer binder.

In the event of fires in buildings with steel framework construction, the temperature of unprotected steel quickly increases to a point where the steel loses its rigidity and compromises the integrity of the structure. Insulating the steel can increase the time to reach the point at which the structure becomes unstable. Intumescent coatings form an insulative foam on the surface of the steel only when exposed to heat or flame. Usually, intumescent coatings require a primer coating. Liquid primer coatings are prone to damage. In off-site application of the coating, liquid systems have proven difficult and slow to apply as well as requiring significant repair once the structure is erected. In on-site application, the wet coating has to dry and is easily damaged.

### SUMMARY

This section provides a general summary of the disclosure and is not a comprehensive disclosure of its full scope or all of its features.

The present disclosure provides a primer composition for coating a substrate prior to application thereon of an intumescent fire protecting coating, which is less prone to damage.

In an aspect, the present disclosure provides a primer composition for coating a substrate prior to application thereon of an intumescent fire protecting coating composition, the primer composition being a powder coating composition consisting of an extruded and subsequently ground mixture of binding agents, hardening agents and optionally one or more of optional pigments, optional filler, and optional additives, and a porous material in a proportion of one to twelve percent by weight of the powder coating composition. The porous material is mesoporous or microporous.

In a further aspect of the present disclosure, a coating system includes a primer composition according and an intumescent fire protecting coating composition configured to be applied onto the primer composition. The primer composition is a powder coating composition consisting of an extruded and subsequently ground mixture of binding agents, hardening agents and optionally one or more of optional pigments, optional filler, and optional additives, and a porous material in a proportion of one to twelve percent by weight of the powder coating composition. The porous material is mesoporous or microporous.

In a further aspect of the present disclosure, a method for production of a powder coating composition as a primer for coating a substrate prior to application thereon of an intumescent fire protecting coating composition includes processing binding agents and hardening agents in an extruder to form an extrudate, grinding the extrudate to form a ground extrudate, and blending the ground extrudate with a porous material with a proportion of one to twelve percent by weight of the powder coating composition. The porous material is mesoporous or microporous.

In yet a further aspect of the present disclosure, a method of coating a steel structural member with a coating system includes applying a primer composition to the steel structural member and then applying an intumescent fire protecting coating composition on the primer composition. The coating system includes a primer composition according and an intumescent fire protecting coating composition configured to be applied onto the primer composition. The primer composition is a powder coating composition consisting of an extruded and subsequently ground mixture of binding agents, hardening agents and optionally one or more of optional pigments, optional filler, and optional additives, and a porous material in a proportion of one to twelve percent by weight of the powder coating composition. The porous material is mesoporous or microporous.

In yet a further aspect of the present disclosure, a porous material is used in the production of a powder coating composition for coating a substrate prior to application thereon of an intumescent fire protecting coating composition. The powder coating composition consists of: an extruded and ground mixture of binding agents, hardening agents, and optionally one or more of optional pigments, optional filler, and optional additives; and a porous material in a proportion of one to twelve percent by weight of the powder coating composition. The porous material is blended or bonded into the ground mixture and the porous material is mesoporous or microporous.

In one form, the primer composition for coating a substrate prior to application thereon of an intumescent fire protecting coating composition is a powder coating composition consisting of: an extruded and subsequently ground mixture of binding agents, hardening agents and optionally one or more of pigments, filler and additives; and a porous material in a proportion of one to twelve percent by weight of the powder coating composition.

The powder coating primer is advantageously more durable than a fluid primer composition. The primer composition is a solvent-free and environment-friendly coating, which is generally applied electrostatically to the substrate, on which it may be cured by baking or by radiative energy. The powder coating composition containing a porous material in a proportion of one to twelve percent by weight advantageously provides a primed surface to which the intumescent fire protecting coating composition can adhere and particularly preserves the adherence under the impact of heat or fire. In the sense of the disclosure, the porous material is a material containing pores or voids. It may be characterized by its porosity and/or the medium diameter of the pores.

Regarding a further aspect of a coating system, in particular for steel structures, the coating system includes the primer and an intumescent fire protecting coating composition to be applied onto the primer. The intumescent fire protecting coating composition may be liquid, for example water-based or solvent-based.

Regarding a further aspect of a process for the production of a powder coating composition as a primer for coating a substrate prior to application thereon of an intumescent fire protecting coating composition, binding and hardening agents, and as optional components pigments, fillers and additives are processed in an extruder, wherein an extrudate obtained in this way is ground and wherein a porous material is subsequently blended in with a proportion of one to twelve percent by weight of the powder coating composition.

Regarding a further aspect of a process for coating a steel structural member with the coating system, the primer is applied to the steel structural member and then the intumescent fire protection coating is applied on the primer.

Regarding a further aspect of a use of a porous material in the production of a powder coating composition for coating a substrate prior to application thereon of an intumescent fire protecting coating composition, the powder coating composition consists of: an extruded and ground mixture of binding agents, hardening agents and optionally one or more of pigments, filler and additives; and a porous material in a proportion of one to twelve percent by weight of the powder coating composition. The porous material is blended into the ground mixture.

In one form of any one of the aspects, the proportion of the porous material can be three to ten percent by weight of the powder coating composition. In one form, the proportion of the porous material can be five to seven percent by weight of the powder coating composition.

In one form, the porous material is diatomaceous earth or another natural or synthetic microporous material, such as a zeolite or active alumina.

In another form of any one of the aspects, the porous material can be blended into the milled mixture. The adherence of the intumescent fire protecting coating composition to the substrate coated with the primer composition, may advantageously be enhanced by bonding the porous material to powder coating particles of the milled mixture. In particular, the application behavior is improved by bonding the porous material. When mixing in the porous material, the deposition efficiency is reduced. Starting at approximately 4% and more of admixture, the desired layer thickness may not be achieved any more. By bonding, this effect is reduced or shifted to higher additive quantities. Further, bonded powder compositions have better processability and stability than non-bonded powder compositions, especially in continuous systems with powder circulation. The porous material bonded to the powder matrix results in a significantly improved adhesion of the intumescent coating in case of fire.

For example, the porous material is bonded in a mixer to the powder coating particles of the ground mixture. The powder coating composition is generally prepared by mixing the constituents and homogenizing the melted mixture in the extruder. Subsequently, solid lumps of extruded powder coating composition ground to the desired particle size. The porous material, however, owing to the grinding process employed during the preparation of the powder coating composition, can be destroyed, at least to a significant portion. Advantageously, the destruction of the porous material can be inhibited by admixing it to the powder coating composition after grinding, which is also called dry-blending. Mainly due to different particle sizes and less important due to different densities and electrostatic charging behavior of the extruded powder coating particles and the porous material, the powder coating composition may segregate. The effect of segregation can advantageously be reduced by the bonding process, wherein a uniform adhesion of the porous material to surfaces of the extruded powder coating particles is achieved. By heating the extruded powder coating particles to almost glass transition temperature Tg, the porous material is bonded to the powder coating particles, thus reducing the segregation.

The porous material is mesoporous or microporous. The mesoporous material, for example, contains pores with diameters between 2 and 50 nanometers. In this context, mesoporosity refers to a classification of nanoscale porosity. Advantageously, the porous material can be microporous, containing pores with diameters less than 2 nanometers. Examples of microporous materials include zeolites and metal-organic frameworks. According to one variation, the porous material can be diatomaceous earth or another natural or synthetic microporous material.

In one form of the primer composition, the optional pigments are titanium dioxide, the optional filler is one or more of calcium carbonate, talc and barium sulfate, and the optional additives are a levelling agent, such as polyacrylate, and/or a degassing agent, such as benzoin.

In the following, the disclosure is illustrated with reference to implementation examples.

### EXAMPLES

Without further elaboration, one skilled in the art can, using the preceding description, utilize the aspects of the disclosure to its full extent. The following exemplary specific forms are therefore to be construed as merely illustrative. In the foregoing and in the following examples, all temperatures are set forth uncorrected in degrees Celsius, and, unless otherwise indicated, all parts and percentages are by weight.

### Example 1

Primer composition for coating a substrate prior to application thereon of an intumescent fire protecting coating composition, the primer composition being a powder coating composition consisting of a first basic formulation for one of the group of epoxy-polyester, polyester/polyurethane and epoxy base, consisting of
binding and hardening agents: 50.00%,
levelling agent: 0.30%,
degassing agent: 0.50%,
titanium dioxide: 7.50%,
tinting pigments 0.60%, and
filler: 41.10%,
   the first basic formulation being extruded and subsequently ground. The primer composition is subsequently obtained by bonding the porous material into the first basic formulation in a bonding mixer, the resulting powder coating composition consisting of the first basic formulation: 94.00% and diatomaceous earth: 6.00%.

Example 1 is a generic composition in regard to the binding and hardening agents. A coating system to be applied to a steel structure includes the primer composition of example 1 and an intumescent fire protecting coating composition to be applied onto the primer composition. The intumescent fire protecting coating composition may be liquid, for example water-based or solvent-based.

### Example 2

Primer composition for coating a substrate prior to application thereon of an intumescent fire protecting coating composition, the primer composition being a powder coating composition consisting of a second basic formulation for epoxy-polyester, consisting of
epoxy resin: 15.00%,
acidic polyester resin: 35.00%,
levelling agent: 0.10%,
degassing agent: 0.10%,
titanium dioxide: 7.50%,
tinting pigments: 0.60%,
calcium carbonate: 40.20%, and
talc: 1.50%,
   the second basic formulation being extruded and subsequently ground. The primer composition is subsequently obtained by bonding the porous material into the second basic formulation in a bonding mixer, the resulting powder coating composition consisting of the second basic formulation: 94.00% and diatomaceous earth: 6.00%.

A coating system to be applied to a steel structure includes the primer composition of example 2 and an intumescent fire protecting coating composition to be applied onto the primer composition. The intumescent fire protecting coating composition may be liquid, for example water-based or solvent-based.

### Reference Example

Powder coating composition consisting of
epoxy resin: 15.00%,
acidic polyester resin: 35.00%,
levelling agent: 0.10%,
degassing agent: 0.10%,
titanium dioxide: 7.50%,
tinting pigments: 0.60%,
calcium carbonate: 40.20%, and
talc: 1.50%.
   Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a photograph illustrating a laboratory fire test of a coating system in accordance with the teachings of the present disclosure;

FIG. 2 shows a diagram representative of a measured microroughness of an exemplary liquid primer composition in accordance with the teachings of the present disclosure;

FIG. 3 shows a diagram representative of a measured microroughness of the primer composition according to the reference example in accordance with the teachings of the present disclosure;

FIG. 4 shows a scanning electron microscope (SEM) image of a diatomaceous earth in accordance with the teachings of the present disclosure;

FIGS. 5 to 7 show SEM images of a surface of the primer composition according to example 2 after application in accordance with the teachings of the present disclosure;

FIG. 8 shows a light optical microscope image of the surface of the primer composition according to example 2 after application in accordance with the teachings of the present disclosure;

FIG. 9 shows a photograph of the coating system including a primer composition according to the reference example after completion of the laboratory fire test in accordance with the teachings of the present disclosure;

FIG. 10 shows a photograph of a further coating system including the primer composition according to the reference example after completion of the laboratory fire test in accordance with the teachings of the present disclosure; and

FIG. 11 shows a photograph of a coating system including a primer composition according to example 2 after completion of the laboratory fire test in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

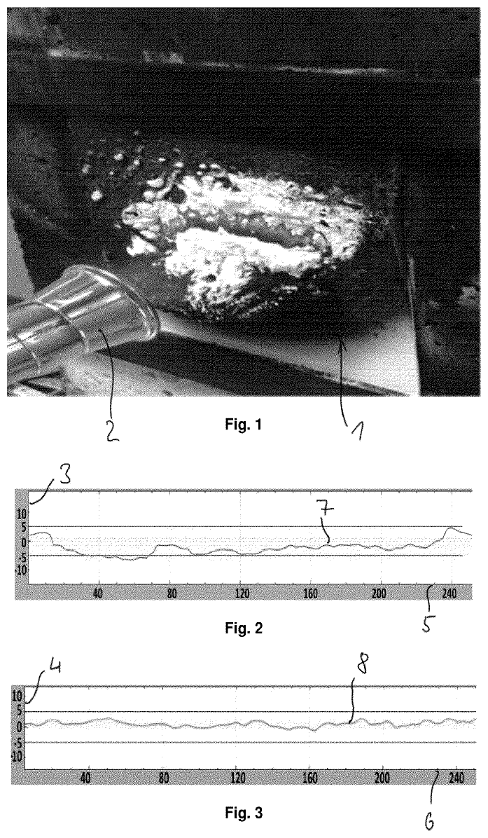

In FIG. 1 a photograph of an exemplary laboratory fire test is shown. A substrate coated with an intumescent layer 1 is subjected to fire with a gas burner 2. For many applications in steel construction, powder coating provides high-quality corrosion protection and a decorative layer. For steel structures that have to be coated with an intumescent layer for improved fire resistance, however, liquid coating systems are used, which are applied manually, as commercially available powder primers do not provide the required and certified fire protection class. State of the art powder coatings as primers for fire protection coatings provide poor adhesion of the intumescent layer on powder coatings. Intumescent layers have a low binder content of typically below 10%, which is one reason for a weak dry adhesion.

However, the decisive factor for failure is the slipping of the foaming intumescent layer in a fire test. Foaming of the intumescent layer occurs at temperatures of 250-300° C. Whether the adhesion between the primer and the intumescent layer is sufficient is thus tested in fire tests.

Relevant mechanisms for adhesion between coating layers are the chemical valence bond between functional groups and the physical adherence of rough surfaces, which is referred to with regard to FIGS. 2 and 3 now. In FIG. 2, a diagram representative of a measured microroughness of a liquid primer composition approved for fire protection systems is shown. In FIG. 3, a diagram representative of a measured microroughness of the primer composition according to the reference example is shown. The respective ordinate axes 3, 4 represent a deviation of the respective surfaces from a nominal value of zero in μm over a length dimension in μm on the abscissae axes 5, 6. As can be seen in the curve 7, the deviations of the liquid primer surface are about twice as high as those of the smoother powder coating primer, represented by the curve 8. An increase in the microroughness of powder coatings, which improves the adhesion values, is advantageously achieved by blending in a porous material subsequently to grinding with a proportion of one to twelve percent by weight of the powder coating composition. Even more advantageously, capillary forces wielded by the porous material are effective in the molecular range. The narrower the capillary, the greater the effect. For example, the natural raw material diatomaceous earth, a deposit of the silicate shells of diatoms, is capable of absorbing up to three times its own weight in liquid and binding it.

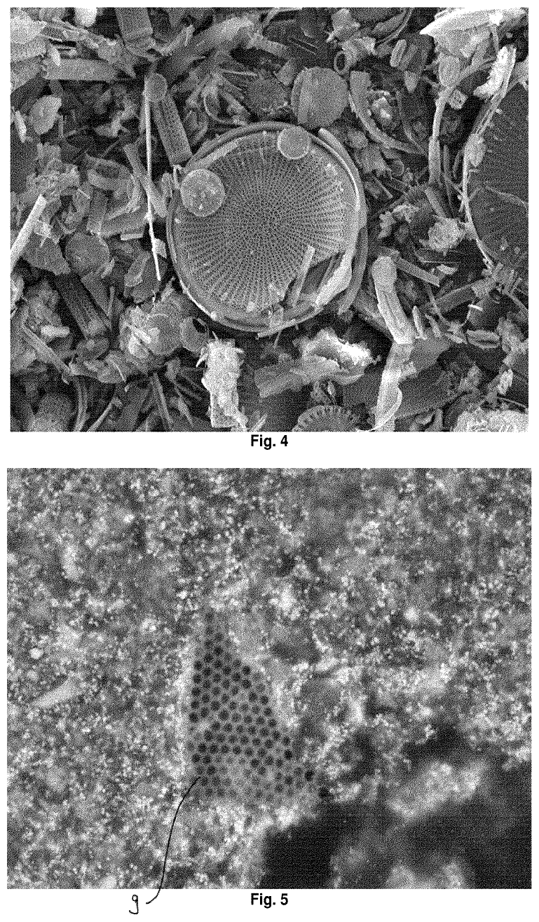

In FIG. 4, a scanning electron microscope (SEM) image of diatomaceous earth is shown. To take advantage of the additional adhesion provided by the capillary forces, the diatomaceous earth particles should be present on the surface of the coating layer as unbroken as possible. This can be achieved by dry-blending the diatomaceous earth into the powder coating composition subsequent to grinding. This procedure has the additional advantage that the binder chemistry and formulation of the powder coating composition have little influence on the adhesion result.

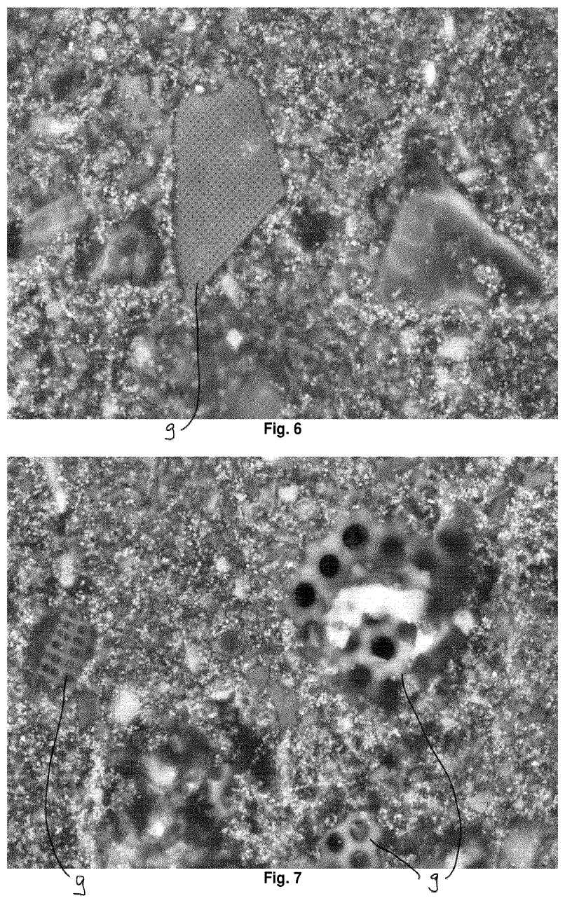

In FIGS. 5 to 7, SEM images of a surface of the primer composition according to example 2 after application are shown. The SEM images of the primer layer illustrate that unchanged fragments 9 of diatomaceous earth are present on the surface.

In FIG. 8, a light optical microscope image of the surface of the primer composition according to example 2 after application is shown. The scale 10 has a length of 500 μm. The light optical microscope image illustrates that the primer composition surface further provides sufficient roughness for a good mechanical adhesion.

The presence of unaltered, unbroken fragments of diatomaceous earth on the primer surface and the increased roughness provide enhanced adhesion properties of the primer to the intumescent layer. The capillary forces of the diatomaceous earth advantageously absorb solvents and binders of the foaming intumescent layer, thus maintaining the firm adhesion under the impact of heat and/or fire.

The desired amount of diatomaceous earth for safe adhesion may disturb the processing of the primer powder during electrostatic application. To enhance application behavior, even in automatic application systems, the diatomaceous earth can be blended into the powder coating composition subsequent to grinding by way of bonding the diatomaceous earth particles in a mixer to the powder coating particles of the ground mixture.

Experiment 1: X-cut test: To test the adhesion of intumescent layers to powder primers, three millimeter thick steel sheets were primed, once with the primer composition according to example 2 and as a reference with the primer composition according to the reference example. Subsequently, identical ˜500 μm thick intumescent layers of Sika® Pyroplast® ST-100 were applied onto the primer layers. According to DIN EN ISO 16276-2, Corrosion protection of steel structures by protective paint systems —Assessment of, and acceptance criteria for, the adhesion/cohesion (fracture strength) of a coating—Part 2: Cross-cut testing and X-cut testing”, the X-cut testing is applicable for coatings over 250 μm thickness. A cut in the form of an X (X-cut) is made into the coating, penetrating through to the substrate. X-cut test results are shown in Table 1 below.

TABLE 1

| Primer | | | Top Coat | | Adhesion |
|---|---|---|---|---|---|
| | | Thickness | | Thickness | Result |
| Code | Surface | (μ) | | (μ) | X cut |
| D002014 Trial 12 | Tex. | 60-95 | Sika | ~500 | ✓ Perfect |
| D002014 Trial 13 | Tex. | 55-80 | 100 | ~500 | ✓ Very good |
| D002014 Trial 14 | Tex. | 55-70 | | ~500 | ✓ Very good |
| D002014 Trial 15 | Tex. | 50-75 | | ~500 | ✓ Perfect |
| D002014 Trial 16 | Tex. | 60-75 | | ~500 | ✓ Good |
| D002014 Trial 17 | Tex. | 50-90 | | ~500 | ✓ Perfect |

Table 1: D002014 Trial 12-17 denominate the primer composition according to example 2 with the given thickness, applied on steel sheets (Tex. means an increased surface roughness attained through additive). About 500 μm thick layers of Sika® Pyroplast® ST-100 were applied onto the primer layers. Adhesion results of the X-cut test are given in the right column.

To test the adhesion of intumescent layers to powder primers, three millimeter thick steel sheets were primed, now with the primer composition according to the reference example and other primers according to the state of the art. Subsequently, again identical ˜500 μm thick intumescent layers of Sika® Pyroplast® ST-100 were applied onto the primer layers. The X-cut test could not be executed correctly as the adhesion of the intumescent layer to the primer was too weak, cf. Table 2 below.

TABLE 2

| Primer | | | Top Coat | | |
|---|---|---|---|---|---|
| | | Thickness | | Thickness | |
| Code (curing cond.) | Surface & Type | (μ) | Code | (mm) | Adhesion Result |
| thermoset #1 (180° C. & 5′) | Tex. & EP-MATT | 70-80 | Sika 100 | 1.2-1.3 | X (visually good adhesion |
| | | | | | but no bonding, bad) |
| thermoset #1 (180° C. & 10′) | Tex. & EP-MATT | 70-80 | Sika 100 | 1.2-1.3 | X (visually good adhesion |
| | | | | | but no bonding, bad) |
| thermoset #2 (180° C. & 5′) | Smooth & PP-MAT | 60-70 | Sika 100 | 1.2-1.3 | X (visually little adhesion, |
| | | | | | no bonding, bad) |
| thermoset #2 (180° C. & 10′) | Smooth & PP-MAT | 60-70 | Sika 100 | 1.2-1.3 | X (bad) |
| thermoset #3 (180° C. & 5′) | Tex. & PP-MAT | 60-70 | Sika 100 | 1.2-1.3 | X (bad) |
| thermoset #3 (180° C. & 10′) | Tex. & PP-MAT | 60-70 | Sika 100 | 1.2-1.3 | X (no adhesion) |
| thermoset #4 (180° C. & 10′) | Smooth & EP-S.GLZ | 60-70 | Sika 100 | 1.2-1.3 | X (no adhesion) |
| thermoplastic | smooth | thicker | Sika 100 | thinner | X (no adhesion) |

Table 2: Four different thermoset primers, followed by the curing conditions temperature (180° C.) and time (5 or 10 minutes) and one thermoplastic primer are listed. The surface property of the steel plate is given (Tex. means an increased roughness attained through additive compared to a smooth surface), and the thermoset primer base (EP—epoxy-based primer, PP—polyester-based primer, matt or glossy).

Experiment 2: fire test: As noted before, one further factor for failure is tested in a fire test, wherein foaming of the intumescent layer occurs at temperatures of 250-300° C. During the fire test the foaming intumescent layer must not slip of the primer layer.

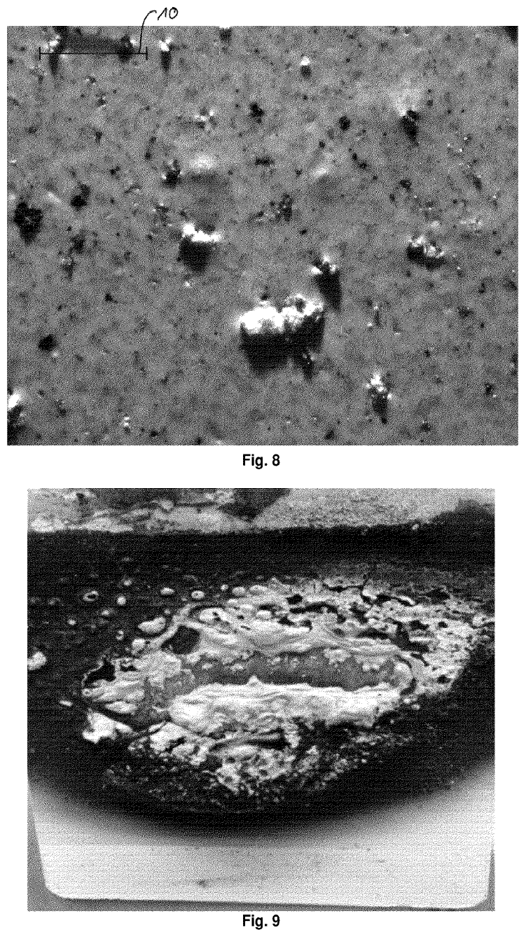

In FIG. 9, a photograph of the coating system including a primer composition according to the reference example is shown, which was taken after completion of the laboratory fire test as described above. The intumescent layer slipped in the laboratory test, i.e., the coating system failed.

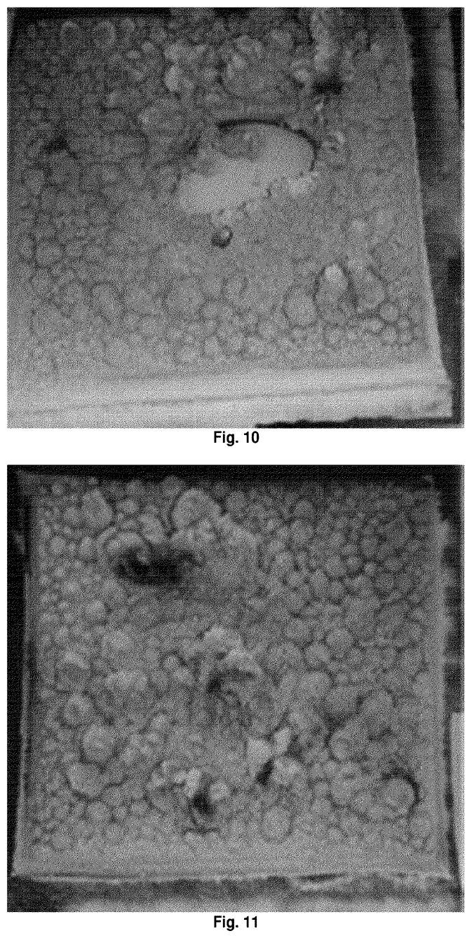

In FIG. 10, a photograph of a further coating system including the primer composition according to the reference example after completion of another laboratory fire test is depicted. For this laboratory fire test boards dimensioned 500 mm×500 mm×5 mm were coated as described above. A drop and/or slipping of the intumescent layer can be observed, which means that the tests according to EN 13381-8 are not passed.

In FIG. 11, a photograph of a coating system including a primer composition according to example 2 after completion of the laboratory fire test is depicted. If the intumescent layer remains closed, the test according to EN 13381-8 is passed. After completion of the laboratory fire test, the intumescent layer does not show any failure or slip. The powder primer composition according to example 2 with the intumescent layer fulfils the fire protection tests according to EN 13381-8 and EN 1363-1.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A primer composition for coating a substrate prior to application thereon of an intumescent fire protecting coating composition, the primer composition being a powder coating composition consisting of:
an extruded and subsequently ground mixture of binding agents, hardening agents and optionally one or more of optional pigments, optional filler, and optional additives; and
a porous material in a proportion of one to twelve percent by weight of the powder coating composition,
wherein the porous material is mesoporous or microporous.

2. The primer composition according to claim 1, wherein the proportion of the porous material is three to ten percent by weight of the powder coating composition.

3. The primer composition according to claim 1, wherein the proportion of the porous material is five to seven percent by weight of the powder coating composition.

4. The primer composition according to claim 1, wherein the porous material is blended into the extruded and subsequently ground mixture of binding agents.

5. The primer composition according to claim 1, wherein the porous material is bonded to powder coating particles of the extruded and subsequently ground mixture of binding agents.

6. The primer composition according to claim 1, wherein the porous material is diatomaceous earth or another natural or synthetic microporous material.

7. The primer composition according to claim 6, wherein the porous material is a zeolite or active alumina.

8. The primer composition according to claim 1, wherein the optional pigments comprise titanium dioxide, the optional filler comprises one or more of calcium carbonate, talc, and barium sulfate, and the optional additives comprise a levelling agent.

9. The primer composition according to claim 8, wherein the levelling agent comprises a polyacrylate, a degassing agent, or both the polyacrylate and the degassing agent.

10. The primer composition according to claim 9, wherein the leveling agent comprises benzoin.

11. A coating system, wherein the coating system comprises a primer composition according to claim 1 and an intumescent fire protecting coating composition configured to be applied onto the primer composition.

12. The coating system according to claim 11, wherein the intumescent fire protecting coating composition is liquid.

13. A method of coating a steel structural member with the coating system according to claim 8, the method comprising:
applying the primer composition to the steel structural member and then applying the intumescent fire protecting coating composition on the primer composition.

14. A method for production of a powder coating composition as a primer for coating a substrate prior to application thereon of an intumescent fire protecting coating composition, the method comprising:
processing binding agents and hardening agents in an extruder to form an extrudate;
grinding the extrudate to form a ground extrudate; and
blending the ground extrudate with a porous material with a proportion of one to twelve percent by weight of the powder coating composition,
wherein the porous material is mesoporous or microporous.

15. The method according to claim 14, wherein the porous material is bonded in a mixer to powder coating particles of the ground mixture.
